(19) United States
(12) Patent Application Publication
(10) Pub. No.: US 2012/0162508 A1
(43) Pub. Date: Jun. 28, 2012

(54) VIDEO DATA CONVERSION APPARATUS

(76) Inventor: Tadayoshi OKUDA, Osaka (JP)

(21) Appl. No.: 13/338,645

(22) Filed: Dec. 28, 2011

(30) Foreign Application Priority Data
Dec. 28, 2010 (JP) 2010-292070

(51) Int. Cl. H04N 7/01

(52) U.S. Cl. 348/459; 348/E07.003

(57) ABSTRACT

A video data conversion apparatus can convert inputted video data in a predetermined scanning format into video data in another scanning format. The inputted video data in the predetermined scanning format is video data at 60 fields per second in a 4:2:2:2 format. The video data in the 4:2:2:2 format is video data in a format where four fields generated from one original image, two fields generated from a next original image, two fields generated from a further next original image, and two fields generated from a further next original image appear periodically in this order. The video data conversion apparatus includes a conversion unit operable to convert the inputted video data into video data at 60 frames per second in a 3:2 pulldown format.

### BACKGROUND

1. Technical Field

The technical field relates to a video data conversion apparatus capable of converting inputted video data in a predetermined scanning format into video data in another scanning format.

2. Related Art

There exist flat display panels such as liquid crystal displays and plasma displays as display devices. These displays generally adopt a progressive format as a scanning format. Accordingly, if the scanning format of inputted video data is different from a format available on the display, scan-conversion may be needed. For example, if inputted video data is interlaced format video data (hereinafter referred to as “interlaced video data”), the video data is scan-converted into progressive format video data (hereinafter referred to as “progressive video data”) to be displayed.

A description will be given of a case of converting a video content of a motion picture film (progressive video data) at 24 frames per second (including 23.976 frames per second) as an example of the conversion of a scanning format. At a broadcast station, an authoring studio, and the like, telecine equipment is used to scan-convert a video content of a motion picture film (video data of progressive format. Hereinafter, referred to as “video data of motion picture film”) at 24 frames per second into interlaced video data at 60 fields per second by the 3:2 pulldown conversion. The obtained interlaced video data at 60 fields per second is inputted into a moving image encoder to be encoded (compressed), and then a video stream is generated.

The “3:2 pulldown conversion” is conversion where an operation of turning the first frame of two consecutive frames of a film source into two fields of interlaced video and the next frame into three fields of the interlaced video is repeated over all the frames of the film source, and is generally and widely used. In this conversion system, two fields in interlaced video data equivalent to three fields video data are turned into the same fields (video data). As a result, overlaps of the same fields (video data) are to be included in the interlaced video data at 60 fields per second generated by the 3:2 pulldown conversion.

A video stream encoded by a moving image encoder is broadcast on a broadcast wave from a base station of a broadcast station, is recorded to disc media such as BDs and DVDs to be delivered, or is distributed via a communication network such as the Internet.

A receiving device decodes a compressed video stream to be delivered or distributed via the above communication infrastructure. If the receiving device outputs progressive video data, interlaced video data at 60 fields per second is scan-converted into progressive video data at 60 frames per second. For example, JP-A-2002-330311 and JP-A-03-250881 propose scan-conversion methods therefor. Specifically, the receiving device detects the regularity of video data generated by the 3:2 pulldown conversion and locates a video signal unit formed by the 3:2 pulldown conversion.

The regularity appears in a five-field cycle in video data generated by the 3:2 pulldown conversion, and is such that a predetermined number-th field of the five fields has the same content as a field two fields after the predetermined number-th field. The video data conversion apparatus combines video data of an odd-numbered field and video data of an even-numbered field constituting the same frame before the 3:2 pulldown conversion for the located video signal unit. Accordingly, scan-conversion from the interlaced video data at 60 fields per second into the progressive video data at 60 frames per second can be realized.

FIG. 14 is a view illustrating the processing of detecting that inputted interlaced video data is video data generated by the 3:2 pulldown conversion (hereinafter referred to as the “3:2 pulldown detection processing” as appropriate). FIG. 14(A) illustrates video data of motion picture film at 24 frames per second (progressive video data at 24 frames per second). FIG. 14(B) illustrates interlaced video data at 60 fields per second generated by the 3:2 pulldown conversion from the video data of the motion picture film at 24 frames per second in FIG. 14(A). The interlaced video data is video data inputted into the video data conversion apparatus. FIG. 14(C) is video data where the video data inputted into the video data conversion apparatus in FIG. 14(B) is delayed by two fields. The video data conversion apparatus calculates differences (field differences) between the video data of FIG. 14(B) and the video data of FIG. 14(C). FIG. 14(D) illustrates the field differences obtained by the computation. Assuming that the value of a field difference is zero if images match with each other, and one if not, there is the regularity that a difference between the same fields results in zero every five fields. Detection of periodic appearances of overlapping fields by use of the regularity makes it possible to detect whether or not the interlaced video data is video data generated by the 3:2 pulldown conversion. FIG. 14(E) is a view illustrating examples of the progressive video data, the interlaced video data, and the video data delayed by two fields.

FIG. 15 is a view illustrating the processing of scan-conversion from video data generated by the 3:2 pulldown conversion into progressive video data at 60 frames per second. FIG. 15(A) illustrates video data of motion picture film at 24 frames per second (progressive video at 24 frames per second). FIG. 15(B) illustrates interlaced video data at 60 fields per second generated by the 3:2 pulldown conversion. The video data generated by the 3:2 pulldown conversion is encoded at a broadcast station to be carried on a broadcast wave and then decoded by a receiving device. FIG. 15(C) illustrates progressive video data at 60 frames per second generated by scan-conversion.

An odd-numbered field b1 and an even-numbered field b2 are combined among fields constituting the interlaced video at 60 fields per second in FIG. 15(B) to generate frames c1 and c2 of progressive video at 60 fields per second in FIG. 15(C). Moreover, an odd-numbered field b3 and an even-numbered field b4 are combined among fields constituting the interlaced video at 60 fields per second in FIG. 15(B) to generate frames c3 and c4 of progressive video at 60 fields per second in FIG. 15(C). Furthermore, an odd-numbered field b5 and an even-numbered field b4 are combined among fields constituting the interlaced video at 60 fields per second in FIG. 15(B) to generate a frame c5 of progressive video at 60 frames per second in FIG. 15(C).

It is possible to obtain the progressive video data at 60 frames per second in the 3:2 format in FIG. 15(C) by subsequently repeating the same processing.

In recent years, with the spread of the Internet, the distribution of video data through the Internet has become widespread. The communication speed through the Internet changes depending on a traffic condition, and is not stable. As a result, the data volume of video data to be distributed through the Internet is set to be smaller than the data volume of video data to be distributed on a broadcast wave (radio wave). For example, the frame rate of video data to be distributed through the Internet is not 60 fields per second, which is used on a broadcast wave, but is set to 30 frames per second. Moreover, the video format of video data to be distributed through the Internet is not interlaced format, but is progressive format in many cases, considering compatibility with reproducing of video data by a personal computer.

If interlaced video data at 60 fields per second generated by the 3:2 pulldown conversion is converted into progressive video data at 30 frames per second to be distributed as described above, the motions of the video may become unnatural when a video processing apparatus receives and plays back the video data.

It is an object to provide a video data conversion apparatus capable of solving a problem such as that, in the case interlaced video data at 60 fields per second generated by the 3:2 pulldown conversion is converted into progressive video data at 30 frames per second to be distributed as described above, the motions of the video become unnatural when a video processing apparatus receives and plays back the video.

### SUMMARY

The inventor discovered that the above problems can occur especially when distributed progressive video data at 30 frames per second is scan-converted into progressive video data at 60 frames per second to be displayed. This will hereinafter be explained specifically.

Firstly, a description will be given of video processing performed when interlaced video data at 60 fields per second generated by the 3:2 pulldown conversion is distributed through the Internet. The flow of the video processing is illustrated in FIG. 16. FIG. 16(A) illustrates interlaced video data at 60 fields per second generated by the 3:2 pulldown conversion from progressive video data at 24 frames per second (a motion picture film). FIG. 16(B) illustrates progressive video data at 60 frames per second generated from the interlaced video data at 60 fields per second in FIG. 16(A). FIG. 16C illustrates progressive video data at 30 frames per second generated from the progressive video data at 60 frames per second in FIG. 16(B). Firstly, whether or not the interlaced video data at 60 fields per second in FIG. 16(A) is video data generated by the 3:2 pulldown conversion is detected based on the regularity described with reference to FIG. 14. If it is detected that the above interlaced video data is video data generated by the 3:2 pulldown conversion, the video data of odd-numbered fields and the video data of even-numbered fields, the video data each constituting the interlaced video data at 60 fields per second in FIG. 16(A), are combined to obtain the progressive video data shown in FIG. 16(B). In other words, scan-conversion is performed. The progressive video data in FIG. 16(B) generated in this manner is then thinned out at intervals of one frame, accordingly, it is possible to obtain the progressive video data at 30 frames per second in FIG. 16C. The progressive video data at 30 frames per second obtained in this manner is then compressed by a moving image encoder to be distributed on the Internet as a video stream.

The distributed video stream is received and played back by a reproducing device such as a BD player or a DVD player on a receiving side. Specifically, a reproducing device such as a BD player or a DVD player decodes the video stream obtained through the Internet, by a decoder circuit. In many cases, the video stream is decoded into interlaced video data in a reproducing device such as a BD player. For example, when the decoded video data shown in FIG. 16C is received in a reproducing device, it is generally converted into interlaced video data at 60 fields per second as shown in FIG. 16D.

In scan-converting the interlaced video data at 60 fields per second, it is detected that the original video data is progressive video data at 30 frames per second, and the video data is converted into progressive format video data at 60 frames per second shown in FIG. 16E.

In interlaced video data generated by the 3:2 pulldown conversion, the first frame of two consecutive frames of the film source is generally displayed as two fields of the video data (video signals), and the next frame as three fields. If progressive video data that is thinned out to 30 frames per second and is transferred in the course of distribution onto the Internet is decoded, images generated from the same images appear in a 10-field cycle of 4 fields, 2 fields, 2 fields, and 2 fields (such video data is hereinafter referred to as “4:2:2:2 format video data”) as in FIG. 16E that illustrates 4 fields generated from a first image, 2 fields generated from a second image, 2 fields generated from a third image, 2 fields generated from a fourth image, 4 fields generated from a fifth image, 2 fields generated from a sixth image, 2 fields generated from a seventh image, 2 fields generated from an eighth image, . . . . Such video data has a problem that the motions of the video are unnatural compared with video data in the 3:2 format generated by the 3:2 pulldown conversion (first problem).

Moreover, in the course of scan-converting interlaced video data at 60 fields per second generated by performing the 3:2 pulldown conversion on video data at 24 frames per second into progressive video data at 60 fields per second, there is a case of thinning out the video data without 3:2 pulldown detection. An example of this case will be shown in FIG. 17.

Interlaced video data at 60 fields per second shown in FIG. 17(A) is generated in the method described with reference to FIG. 15. In this example, the progressive video data shown in FIG. 17(B) can be obtained by combining a pair of adjacent video data of an odd-numbered field and video data of an even-numbered field constituting the interlaced video data at 60 fields per second of FIG. 17(A). As a result, for example, there is a case that progressive video data is generated by combining interlaced video data of fields constituting different frames (T0 and B1, for example). Video according to video data generated by combining video data of field constituting different frames looks smeared when viewed, and changes to progressive video data Ta/Ba that cannot be separated into the same field video data as field video data T0 and B1 in the subsequent processing, by filter processing and the like upon the combination processing. The generated progressive video data in FIG. 17(B) is thinned out at intervals of one frame, accordingly, it is possible to obtain progressive video data at 30 frames per second in FIG. 17(C). The progressive video data at 30 frames per second obtained in this manner is then compressed by a moving image encoder to be distributed onto the Internet as a video stream. Incidentally, in the distributed progressive video data at 30 frames per second, video data generated by combining two video data appears in two consecutive fields in every 5-field cycle as shown in FIG. 17(C). Such video data is hereinafter referred as “1:1:1:1:1 format video data”.

Similar processing to that in the case of FIG. 16 is performed on the distributed progressive video data at 30 frames per second on the receiving side, accordingly, the video data is converted into interlaced video data at 60 fields per second as shown in FIG. 17(D), and is converted into progressive video data at 60 frames per second as shown in FIG. 17(E). The progressive video data in FIG. 17(E) obtained in this manner is the same as the video data shown in FIG. 17(B). Hence, there is a problem that video of the video data looks double or smeared when viewed (second problem). Incidentally, if the distributed progressive video data at 30 frames per second is decoded, fields constituting the same image appear on a two field basis as shown in FIG. 17(D), and video data generated by combining the two video data as in above appears in four consecutive fields in every 10-field cycle. Hereinafter, such video data is referred to as “2:2:2:2:2 format video data.”

Incidentally, in the video data conversion apparatus, there is a case that the distributed video data is converted directly into the progressive video data at 60 frames per second as in FIG. 17(E) without converting the progressive video data (FIG. 17(C)) at the 30 fields per second in the 1:1:1:1:1 format, the video data having been generated in the procedures as in FIG. 17(A), (B), and (C), into interlaced video data at 60 fields per second as in FIG. 17(D). Also in the progressive video data at 60 frames per second, video data generated by combining two video data is included. Accordingly, there is a problem that such video looks double or smeared when viewed (third problem), similarly to the second problem.

Moreover, there is a problem also in a case where video data is scan-converted by a reproducing device such as a BD player. For example, progressive video data at 30 frames per second in a 2:1:1:1 format (to be described in detail later) is inputted into a reproducing device such as a BD player, and the video data is directly scan-converted into progressive video data at 60 frames per second without being scan-converted into interlaced video data at 60 fields per second. In this case, the generated progressive video data at 60 frames per second is turned into in the 4:2:2:2 format. Hence, there is a problem that the motions of video are unnatural also when progressive video data at 30 frames per second is directly scan-converted into progressive video data at 60 frames per second as in above (fourth problem), similarly to the first problem.

As described above, in video data distributed through the Internet, the frame rate is decreased through the 3:2 pulldown conversion and the like, accordingly, there is the problem that the motions of the video are unnatural. Moreover, it is not limited to the distribution through the Internet, but a similar problem may occur also in video data created by a PC or video data shot by a digital still camera with low processing capacity when the frame rate is converted.

The present embodiment has been made considering the above problems, and an object thereof is to provide a video data conversion apparatus capable of solving the problems occurring in a case of converting interlaced video data at 60 fields per second generated by the 3:2 pulldown conversion into progressive video data at 30 frames per second to distribute the video data as described above.

In first to fifth aspects, a video data conversion apparatus capable of converting inputted video data in a predetermined scanning format into video data in another scanning format is provided.

Specifically, the first aspect corresponds to the first problem. In the first aspect, the inputted video data in the predetermined scanning format is video data at 60 fields per second in a 4:2:2:2 format, the video data in the 4:2:2:2 format is video data in a format where four fields generated from one original image, two fields generated from a next original image, two fields generated from a further next original image, and two fields generated from a still further next original image appear periodically in this order. The video data conversion apparatus includes a conversion unit operable to convert the inputted video data into video data at 60 frames per second in a 3:2 pulldown format.

The second aspect corresponds to the first problem. In the second aspect, the inputted video data in the predetermined scanning format is video data at 60 fields per second in a 4:2:2:2 format, the video data in the 4:2:2:2 format is video data in a format where four fields generated from one original image, two fields generated from a next original image, two fields generated from a further next original image, and two fields generated from a still further next original image appear periodically in this order. The video data conversion apparatus includes a conversion unit operable to convert the inputted video data into video data at 24 frames per second where all frames being bases of generation of the video data are different to output the video data.

The third aspect corresponds to the fourth problem. In the third aspect, the inputted video data in the predetermined scanning format is video data at 30 frames per second in a 2:1:1:1 format, the video data in the 2:1:1:1 format is video data in a format where two frames generated from one original image, one frame generated from a next original image, one frame generated from a further next original image, and one frame generated from a still further next original image appear periodically in this order. The video data conversion apparatus includes a conversion unit operable to convert the inputted video data into video data at 60 frames per second in a 3:2 pulldown format to output the video data.

The fourth aspect corresponds to the second problem. In the fourth aspect, the inputted video data in the predetermined scanning format is video data at 60 fields per second in a 2:2:2:2:2 format, the video data in the 2:2:2:2:2 format is video data in a format where two fields generated from one original image, two fields generated from a next original image, two fields generated from the next original image and a further next original frame, two fields generated from the further next original image, and two fields generated from a still further next original image appear periodically in this order. The video data conversion apparatus includes a conversion unit operable to correct the two fields generated from two original images in the inputted video data by use of the original image used for generation of another field, afterwards convert the inputted video data into video data at 60 frames per second in a 3:2 pulldown format to output the video data.

The fifth aspect corresponds to the third problem. In the fifth aspect, the inputted video data in the predetermined scanning format is video data at 30 frames per second in a 1:1:1:1:1 format, the video data in the 1:1:1:1:1 format is video data in a format where one field generated from one original image, one field generated from a next original image, one field generated from the next original image and a further next original image, one field generated from the further next original image, and one field generated from a still further next original image appear periodically in this order. The video data conversion apparatus includes a conversion unit operable to correct the one field generated from the two original images in the inputted video data by use of the original image used for generation of another field, afterwards convert the inputted video data into video data at 60 frames per second in a 3:2 pulldown format to output the video data.

Incidentally, in the present specification, images constituting video data in the 4:2:2:2 format are created based on images constituting four consecutive frames in a film source at 24 frames per second. Assuming that the four frames are referred to as a first frame, a second frame, a third frame, and a fourth frame in chronological order, four images (first group) are created from an image of the first frame. Next two images (second group) Are created from an image of the second frame. Further next two images (third group) are crated from an image of the third frame. Further next two images (fourth group) are created from an image of the fourth frame. In this manner, the image of each group is created from each frame of the film source at 24 frames per second. In other words, the image of each group is created from the image of the same frame.

Incidentally, video data in the 4:2:2:2 format may be interlaced video data or progressive video data.

Moreover, in the present specification, images constituting video data in the 2:1:1:1 format are created based on images constituting four consecutive frames in a film source at 24 frames per second. Assuming that the four frames are referred to as a first frame, a second frame, a third frame, and a fourth frame in chronological order, two images (first group) are created from an image of the first frame. A next image (second group) is created from an image of the second frame. A further next image (third group) is crated from an image of the third frame. A further next image (fourth group) is created from an image of the fourth frame. In this manner, the image of each group is created from each frame of the film source at 24 frames per second. In other words, the image of each group is created from the image of the same frame.

Incidentally, it is preferable that video data in the 2:1:1:1 format should be progressive video data at 30 frames per second.

Moreover, in the present specification, images constituting video data in the 2:2:2:2:2 format are created based on images constituting four consecutive frames in a film source at 24 frames per second. Assuming that the four frames are referred to as a first frame, a second frame, a third frame, and a fourth frame in chronological order, two images (first group) are created from an image of the first frame. Next two images (second group) are created from an image of the first frame and an image of the second frame. Further next two images (third group) are crated from an image of the second frame and an image of the third frame. Further next two images (fourth group) are created from the image of the third frame. Further next two images (fifth group) are crated from an image of the fourth frame. In this manner, the image of the first, fourth, and fifth groups are created from one frame each. However, the images of the second and third groups are created from two frames each. Accordingly, the images of the second and third groups look double or smeared when viewed.

Moreover, in the present specification, images constituting video data in the 1:1:1:1:1 format are created based on images constituting four consecutive frames in a film source at 24 frames per second. Assuming that the four frames are referred to as a first frame, a second frame, a third frame, and a fourth frame in chronological order, one (first) image is created from an image of the first frame. A next (second) image is created from an image of the first frame and an image of the second frame. A further next (third) image is crated from an image of the second frame and an image of the third frame. A further next (fourth) image is created from the image of the third frame. A further next (fifth) image is crated from an image of the fourth frame. In this manner, the first, fourth, and fifth images are created from one frame each. However, the second and third images are created from two frames each. Accordingly, the second and third images look double or smeared when viewed.

According to the first aspect of the video data conversion apparatus, the first problem is solved. More specifically, if inputted video data is video data at 60 fields per second in the 4:2:2:2 format, that is to say, if inputted video data is video data where the motions of the video are unnatural when viewed by a user, the inputted video data is converted into video data at 60 frames per second in the 3:2 pulldown format to be outputted. Hence, the unnatural motions of the video upon the user viewing the video are resolved.

According to the second aspect of the video data conversion apparatus, the first problem is solved. More specifically, if inputted video data is video data at 60 fields per second in the 4:2:2:2 format, that is to say, if inputted video data is video data where the motions of the video are unnatural when viewed by the user, the inputted video data is converted into video data at 24 frames per second where all frames, which are bases of the generation of the video data, are different, to be outputted. Hence, the unnatural motions of the video upon the user viewing the video are resolved.

According to the third aspect of the video data conversion apparatus, the fourth problem is solved. More specifically, if inputted video data is video data at 30 frames per second in the 2:1:1:1 format, that is to say, if inputted video data is video data where the motions of the video are unnatural when viewed by the user, the inputted video data is converted into video data at 60 frames per second in the 3:2 pulldown format to be outputted. Hence, the unnatural motions of the video upon the user viewing the video are resolved.

According to the fourth aspect of the video data conversion apparatus, the second problem is solved. More specifically, if inputted video data is video data at 60 fields per second in the 2:2:2:2:2 format, that is to say, if inputted video data is video data that look double or smeared when viewed by the user, one field generated from two original images in the inputted video data is corrected by use of an original image used for the generation of another field, afterwards the corrected video data is converted into video data at 60 frames per second in the 3:2 pulldown format to be outputted. Hence, the problem of the images looking double or smeared when viewed by the user is resolved.

According to the fifth aspect of the video data conversion apparatus, the third problem is solved. More specifically, if inputted video data is video data at 30 frames per second in the 1:1:1:1:1 format, that is to say, if inputted video data is video data that look double or smeared when viewed by the user, one field generated from two original images in the inputted video data is corrected by use of an original image used for the generation of another field, afterwards the corrected video data is converted into video data at 60 frames per second in the 3:2 pulldown format to be outputted. Hence, the problem of the image looking double or smeared when viewed by the user is resolved.

### BRIEF DESCRIPTION OF DRAWINGS

FIG. 1 is a view illustrating an example of a system to which a video data conversion apparatus is applied.

FIG. 2 is a view illustrating a configuration of a video processing apparatus of a first embodiment.

FIG. 3 is a view illustrating a configuration of a part of an LSI of the video processing apparatus of the first embodiment.

FIG. 4 is a view illustrating processing of the video processing apparatus of the first embodiment; specifically, FIG. 4(A) illustrates interlaced video data at 60 fields per second inputted into an AV input/output circuit; FIG. 4(B), (C), and (D) illustrate video data delayed by one field, video data delayed by two fields, respectively, and video data delayed by three fields, which are held by a buffer memory; FIG. 4(E) illustrates values of a sequence counter; and FIG. 4(F) illustrates progressive video data at 60 frames per second, the video data having been scan-converted by a video scan-conversion circuit.

FIG. 5(A) is a view explaining the transition of a two-field difference, and FIG. 5(B) is a view explaining the transition of a one-field difference.

FIG. 6 is a view illustrating the configuration of the video processing apparatus of the second embodiment and a third embodiment.

FIG. 7 is a view illustrating processing of a video processing apparatus of a second embodiment; specifically, FIG. 7(A) illustrates interlaced video data at 60 fields per second inputted into the AC input/output circuit; FIG. 7(B), (C), and (D) illustrate video data delayed by one field, video data delayed by two fields, and video data delayed by three fields, respectively, which are held by the buffer memory; FIG. 7(E) illustrates values of the sequence counter; FIG. 7(F) illustrates progressive video data at 60 frames per second, the video data having been scan-converted by the scan-conversion circuit; and FIG. 7(G) illustrates progressive video data at 24 frames per second outputted from a buffer memory.

FIG. 8 is a view illustrating processing of a video processing apparatus of the third embodiment; specifically, FIG. 8(A) illustrates progressive video data at 30 frames per second inputted into the AC input/output circuit; FIG. 8(B), (C), and (D) illustrate video data delayed by one field, video data delayed by two fields, and video data delayed by three fields, respectively, which are held by the buffer memory; FIG. 8(E) illustrates values of the sequence counter; FIG. 8(F) illustrates progressive video data at 30 frames per second outputted from the video scan-conversion circuit; and FIG. 8(G) illustrates progressive video data at 60 frames per second outputted from the buffer memory.

FIG. 9 is a view illustrating the configuration of a video processing apparatus of a fourth embodiment.

FIG. 10 is a view illustrating processing of the video processing apparatus of the fourth embodiment; specifically, FIG. 10(A) illustrates interlaced video data at 60 fields per second inputted into the AC input/output circuit; FIG. 10(B), (C), and (D) illustrate video data delayed by one field, video data delayed by two fields, and video data delayed by three fields, respectively, which are held by the buffer memory; FIG. 10(E) illustrates values of the sequence counter; FIG. 10(F) illustrates progressive video data at 60 frames per second, the video data having been scan-converted by the video scan-conversion circuit; and FIG. 10G illustrates progressive video data at 24 frames per second outputted from the buffer memory.

FIG. 11(A) is a view explaining the transition of a two-field difference, and FIG. 11(B) is a view explaining the transition of a one-field difference.

FIG. 12 is a view illustrating the configuration of a video processing apparatus of a fifth embodiment.

FIG. 13 is a view illustrating processing of the video processing apparatus of the fifth embodiment; specifically, FIG. 13(A) illustrates progressive video data at 30 frames per second inputted into the AC input/output circuit; FIG. 13(B), (C), and (D) illustrate video data delayed by one field, video data delayed by two fields, and video data delayed by three fields, respectively, which are held by the buffer memory; FIG. 13(E) illustrates values of the sequence counter; FIG. 13(F) illustrates progressive video data at 60 frames per second, the video data having been scan-converted by the video scan-conversion circuit; and FIG. 13(G) illustrates progressive video data at 24 frames per second outputted from the buffer memory.

FIG. 14 is a view illustrating processing of detecting that interlaced video data is video data generated by the 3:2 pulldown conversion; specifically, FIG. 14(A) illustrates video data of motion picture film at 24 frames per second (progressive video data at 24 frames per second); FIG. 14(B) illustrates interlaced video data at 60 fields per second generated by the 3:2 pulldown conversion from the video data of the motion picture film at 24 frames per second in FIG. 14(A); FIG. 14(C) is video data where the video data of FIG. 14(B) is delayed by two fields; FIG. 14(D) illustrates field differences obtained by computation; and FIG. 14(E) is a view illustrating examples of the progressive video data, the interlaced video data, and the video data delayed by two fields.

FIG. 15 is a view illustrating processing of scan-converting interlaced video data at 60 fields per second generated by the 3:2 pulldown conversion into progressive video data; specifically, FIG. 15(A) illustrates video data of motion picture film at 24 frames per second (progressive video data at 24 frames per second); FIG. 15(B) illustrates interlaced video data at 60 fields per second generated by the 3:2 pulldown conversion; and FIG. 15(C) illustrates scan-converted progressive video data at 60 frames per second.

FIG. 16 is a view explaining problems that occur when interlaced video data at 60 fields per second generated by the 3:2 pulldown conversion is converted into progressive video data at 30 frames per second to be distributed through the Internet; specifically, FIG. 16(A) illustrates interlaced video data at 60 fields per second generated by the 3:2 pulldown conversion from progressive video data at 24 frames per second (film footage); FIG. 16(B) illustrates progressive video data at 60 frames per second generated from the interlaced video data at 60 fields per second in FIG. 16(A); FIG. 16C illustrates progressive video data at 30 frames per second generated from the progressive video data at 60 frames per second in FIG. 16(B); FIG. 16D is interlaced video data at 60 fields per second decoded on a receiving side; and FIG. 16E is scan-converted video data at 60 frames per second in the progressive format.

FIG. 17 is a view explaining problems that occur when interlaced video data at 60 fields per second generated without the 3:2 pulldown conversion is converted into progressive video data at 30 frames per second to be distributed through the Internet; specifically, FIG. 17(A) illustrates interlaced video data at 60 fields per second generated by the 3:2 pulldown conversion from progressive video data at 24 frames per second (film footage); FIG. 17(B) illustrates progressive video data at 60 frames per second generated from the interlaced video data at 60 fields per second in FIG. 17(A); FIG. 17(C) illustrates progressive video data at 30 frames per second generated from the progressive video data at 60 frames per second in FIG. 17(B); FIG. 17(D) is interlaced video data at 60 fields per second decoded on the receiving side, and FIG. 17(E) is scan-converted progressive video data at 60 frames per second.

### DETAILED DESCRIPTION OF PREFERRED EMBODIMENT

Embodiments of a video data conversion apparatus will be described.

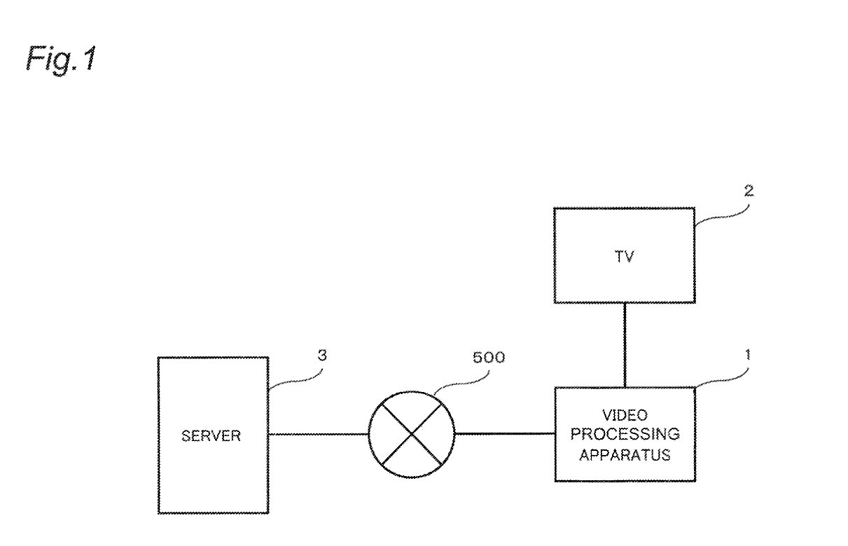

FIG. 1 illustrates an example of a system to which a video data conversion apparatus is applied. The system includes a video processing apparatus 1, a TV (video display device) 2, and a server 3. The video data conversion apparatus is applied to the video processing apparatus 1. The server 3 distributes video data through an internet 500. The video processing apparatus 1 is connectable to the internet 500, receives the video data from the server 3 through the internet 500, and outputs video data which is scan-converted to the TV 2. The TV 2 displays the video based on the video data outputted from the video processing apparatus 1.

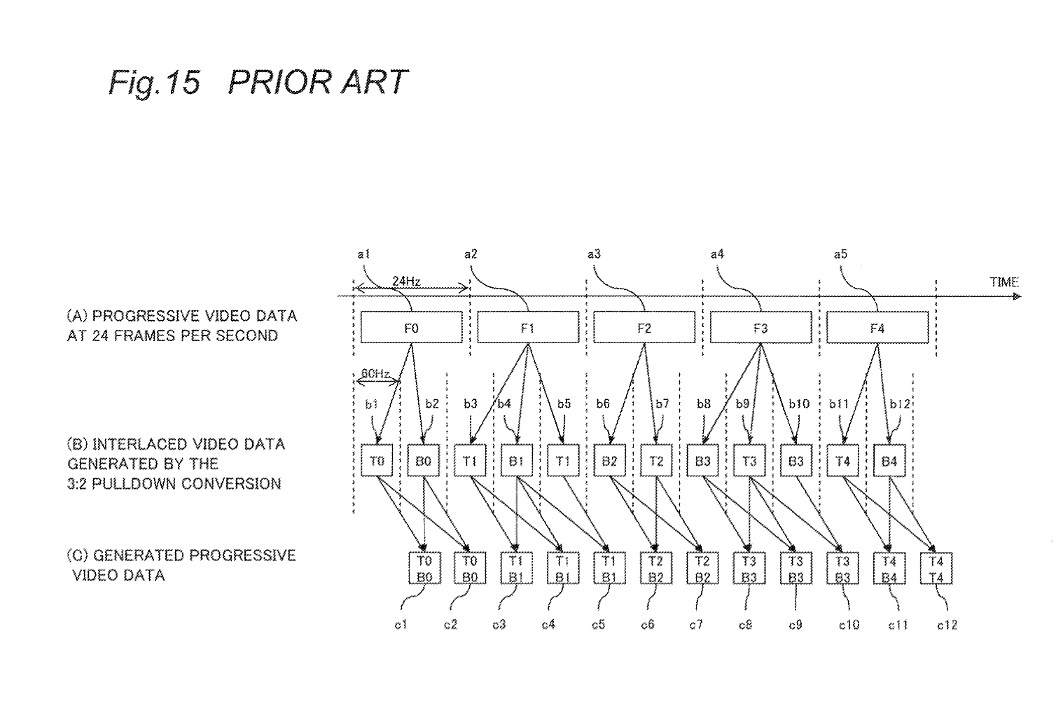

The video data distributed from the server 3 through the internet 500 is usually video data at 30 frames per second. The video data is generated in the following procedures as described with reference to FIG. 15 and the like. Interlaced video data at 60 fields per second is generated by the 3:2 pulldown conversion from a motion picture film at 24 frames per second (including 23.976 frames per second). Next, the interlaced video data at 60 fields per second is converted into progressive video data at 60 frames per second. Then, the progressive video data at 60 frames per second is thinned out at intervals of one frame, accordingly, progressive video data at 30 frames per second is generated. The server 3 sends the progressive video data at 30 frames per second generated in the above manner in a video stream format such as an MPEG.

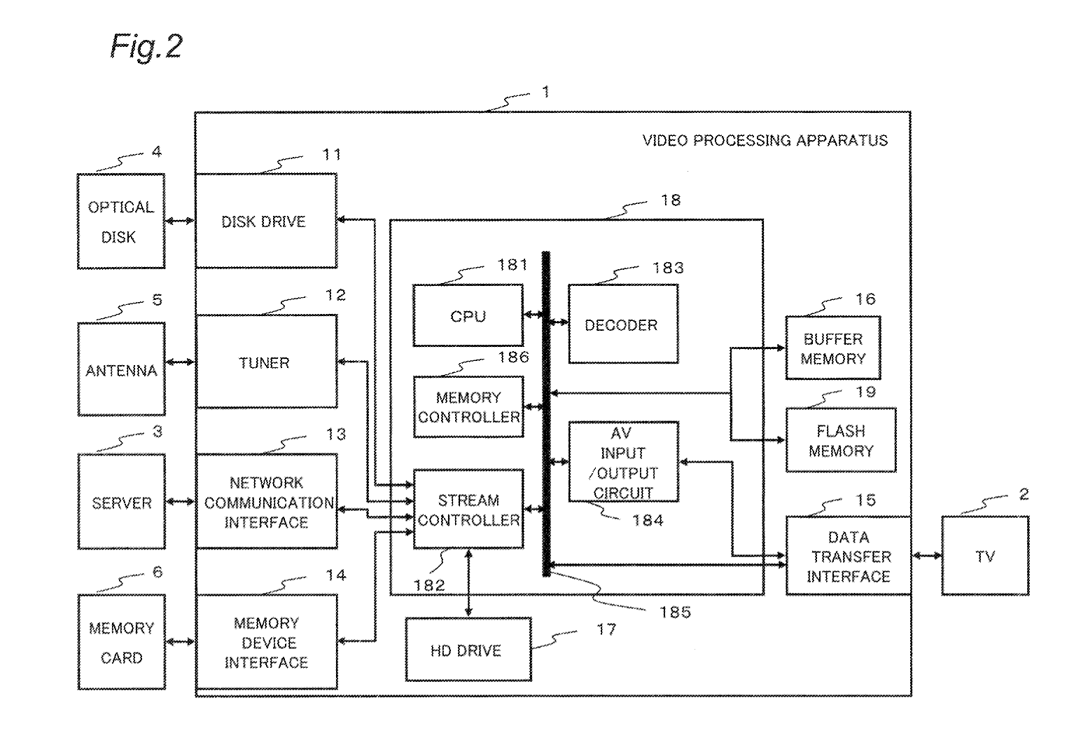

FIG. 2 illustrates the configuration of the video processing apparatus 1. The video processing apparatus 1 includes a disk drive 11, a tuner 12, a network communication interface 13, a memory device interface 14, a data transfer interface 15, a buffer memory (frame memory) 16, an HID drive 17, a flash memory 19, and an LSI 18. The LSI 18 is an example of the video data conversion apparatus.

The disk drive 11 includes an optical pickup, and reads a video stream from an optical disk 4. The disk drive 11 is connected to the LSI 18, and sends the video stream read from the optical disk 4 to the LSI 18. The disk drive 11 reads the video stream from the optical disk 4 in accordance with an instruction from the LSI 18, and sends the video stream to the LSI 18.

The tuner 12 obtains the video stream included in a broadcast wave received by an antenna 5. The tuner 12 extracts from the obtained broadcast wave the video stream in a channel designated by the LSI 18. The tuner 12 is connected to the LSI 18, and sends the extracted video stream to the LSI 18.

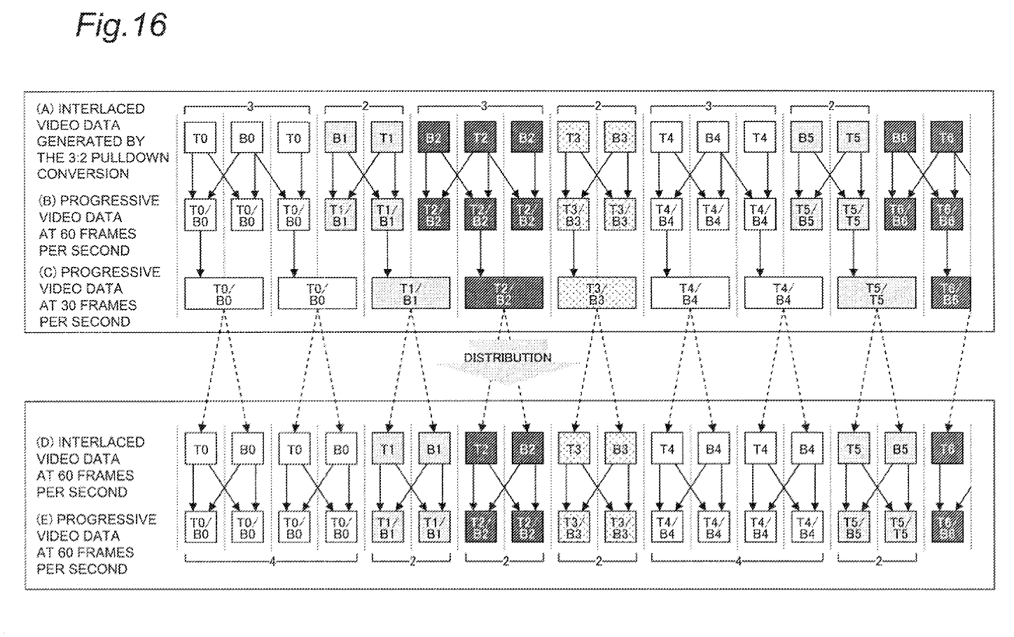

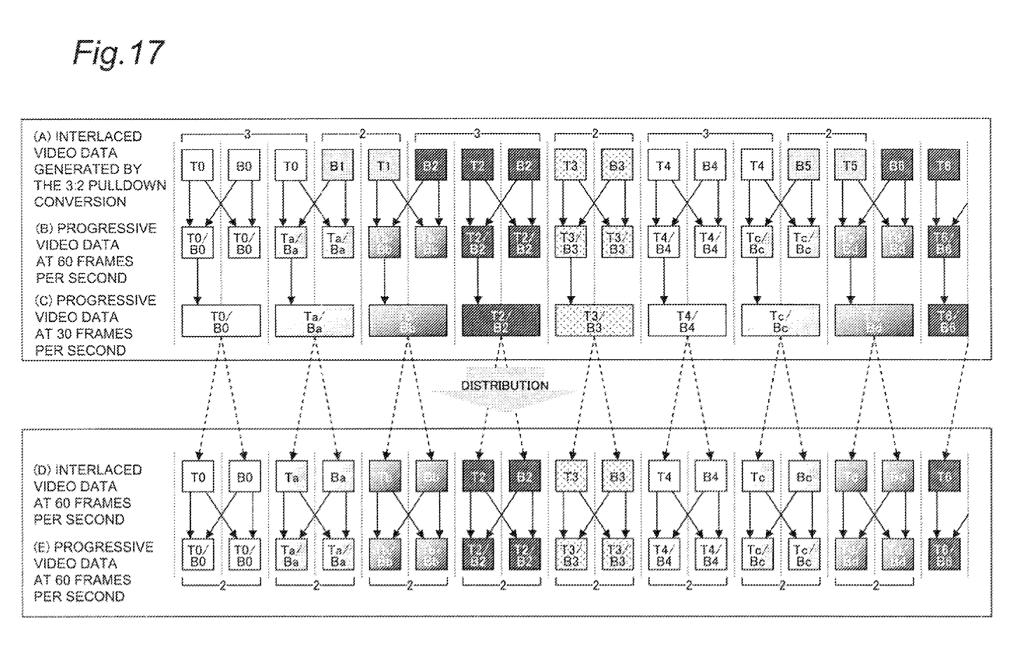

The network communication interface 13 is connectable to the server 3 through the internet 500. The network communication interface 13 obtains the video stream sent from the server 3. The video stream is a video stream of progressive video at 30 frames per second (the video shown in FIG. 16C or 17(C)).

A memory card can be inserted into the memory device interface 14. The memory device interface 14 reads a video stream recorded in the inserted memory card. The memory device interface 14 sends the video stream read from the memory card to the LSI 18.

A recording medium such as a hard disk is embedded in the HD drive 17. The HD drive 17 reads data from the built-in recording medium to send the read data to the LSI 18. Moreover, the RD drive 17 records the data received from the LSI 18 to the built-in recording medium.

The data transfer interface 15 is an interface for sending data sent from the LSI 18 to the external TV 2. The LSI 18 transmits and receives a data signal and a control signal to and from the TV 2 via the data transfer interface 15, and can control the TV 2. The data transfer interface 15 can be realized by an HDMI (High-Definition Multimedia Interface), for example. An HDMI cable includes a data line and a control line. Incidentally, the data transfer interface 15 can have any configuration as long as it can transmit a data signal to the TV 2.

The buffer memory 16 functions as work memory when the LSI 18 performs processing. The buffer memory 16 can be realized by a DRAM or an SRAM, for example.

The LSI 18 is a system controller for controlling each unit of the video data conversion apparatus 1. The LSI 18 may be realized by a microcomputer, or a hard-wired circuit. A CPU 181, a stream controller 182, a decoder 183, an AV input/output circuit 184, a system bus 185, and a memory controller 186 are mounted inside the LSI 18.

A control program for controlling the LSI 18 is stored in the flash memory 19. Moreover, information on a channel, information on a volume, and information on MAC and IP addresses and the like, which are necessary for network communication, information used for adjusting image quality of the video processing apparatus, and the like are recorded in the flash memory 19.

The CPU 181 is a system controller for controlling the entire video processing apparatus 1. Each unit of the LSI 18 performs various control based the control of the CPU 181. Moreover, the CPU 181 controls communications with the outside.

For example, when obtaining a video stream from the server 3, the optical disk 4, the antenna 5, a memory card 6, and the like, the CPU 181 transmits a control signal to the disk drive 11, the tuner 12, the network communication interface 13, the memory device interface 14, and the like. Accordingly, the disk drive 11, the tuner 12, the network communication interface 13, and the memory device interface 14 can obtain the video stream.

The stream controller 182 controls receiving and sending of data between the units constituting the server 3, the optical disk 4, the antenna 5, the memory card 6, and the LSI 18. For example, the stream controller 182 sends the video stream obtained from the server 3 to the memory controller 186. The memory controller 186 writes the data sent from each unit of the LSI 18 into the buffer memory 16. Moreover, the memory controller 186 records the video stream obtained from the stream controller 182, to the buffer memory 16. Moreover, the memory controller 186 reads the data recorded in the buffer memory 16 to send the read data to each unit of the LSI 18.

When obtaining the data from the memory controller 186, the decoder 183 decodes the obtained data. The data is inputted into the decoder 183 based on the control of the CPU 181. Specifically, the CPU 181 controls the memory controller 186 to read the video stream recorded in the buffer memory 16. The CPU 181 then controls the memory controller 186 to send the read video stream to the decoder 183. Accordingly, the video stream is inputted by the memory controller 186 to the decoder 183.

The decoder 183 separates the inputted video stream into compressed and encoded data (video information, audio information, and data information) and header information. The decoder 183 records the separated header information to the buffer memory 16.

Moreover, the decoder 183 decodes the compressed and encoded data based on decoding information included in the header information. Incidentally, the decoder 183 sends the decoded information (video information, audio information, and data information) to the memory controller 186. Video data decoded and outputted by the decoder 183 is interlaced video data at 60 frames per second (the video data shown in FIG. 16D or 17(D)). The memory controller 186 records the information obtained from the decoder 183, to the buffer memory 16.

The AV input/output circuit 184 reads the decoded data and the header information from the buffer memory 16 and generates video data to be displayed on the TV 2. The AV input/output circuit 184 scan-converts the decoded video data at 60 fields per second into video data at 60 frames per second. The AV input/output circuit 184 sends the converted video data to the TV 2 through the data transfer interface 15. A description will hereinafter be given of various embodiments of the video processing apparatus 1.

### First Embodiment

A first embodiment is for solving the above first problem. More specifically, if progressive video data at 30 frames per second generated in the procedures as in FIG. 16 and distributed from the server 3 is scan-converted into progressive video data at 60 frames per second, the video data is turned into video data in the 4:2:2:2 format. If progressive video data at 60 frames per second is generated based on the video data in the 4:2:2:2 format and then is played back, the motions of the video become unnatural. A description will be given of the configuration of a video processing apparatus 1 for solving the problem in the first embodiment.

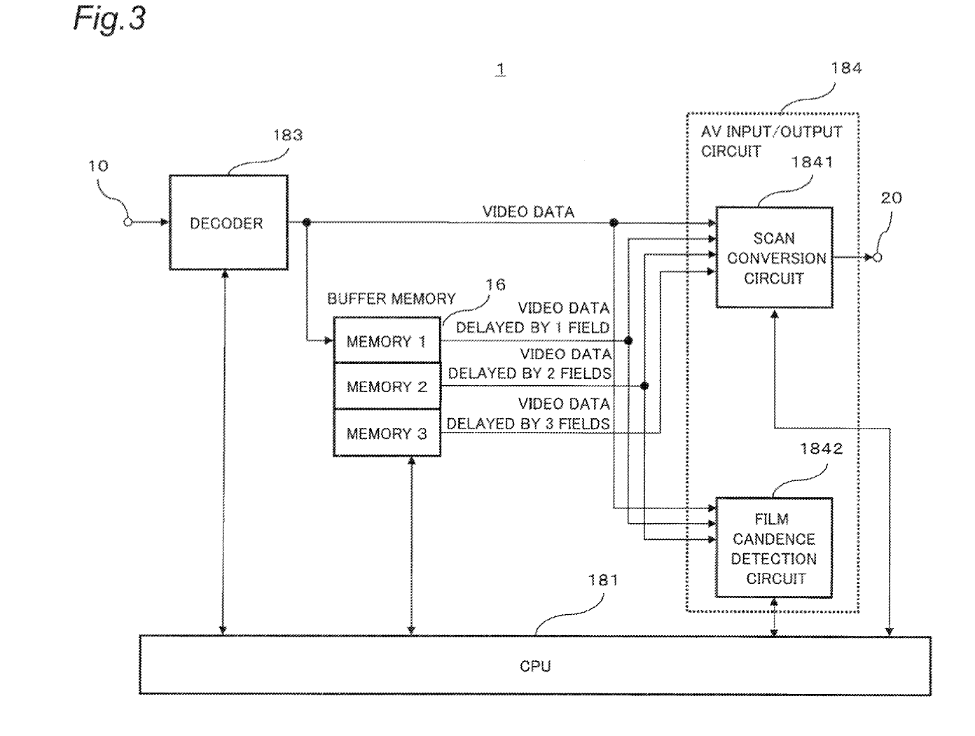

FIG. 3 illustrates the configuration of an important part of the video processing apparatus 1 of the first embodiment. A video stream such as an MPEG is inputted into an input terminal 10. The decoder 183 decodes the inputted video stream of progressive video data at 30 frames per second. The video data generated by the decoding is interlaced video data at 60 frames per second. The buffer memory 16 holds video data equivalent to the past three fields obtained by the decoder 183. That is, the buffer memory 16 includes a memory for storing video data delayed by one field, a memory for storing video data delayed by two fields, and a memory for storing video data delayed by three fields.

An AV input/output circuit 184 includes a scan-conversion circuit 1841 and a film cadence detection circuit 1842.

The film cadence detection circuit 1842 detects whether or not video data targeted for processing is interlaced video data at 60 fields per second generated by the 3:2 pulldown conversion, based on a difference between video data obtained by the decoder 183 and video data delayed by one field and recorded in the buffer memory 16, and a difference between video data obtained by the decoder 183 and video data delayed by two fields.

The scan-conversion circuit 1841 combines video data of two fields in video data of four fields in total of one field outputted by the decoder 183 and the past three fields held by the buffer memory 16, and accordingly converts the video data into progressive video data in the 3:2 pulldown format. The conversion processing is performed based on information obtained by the film cadence detection circuit 1842.

The progressive video generated by the scan-conversion by the AV input/output circuit 184 is outputted from an output terminal 20.

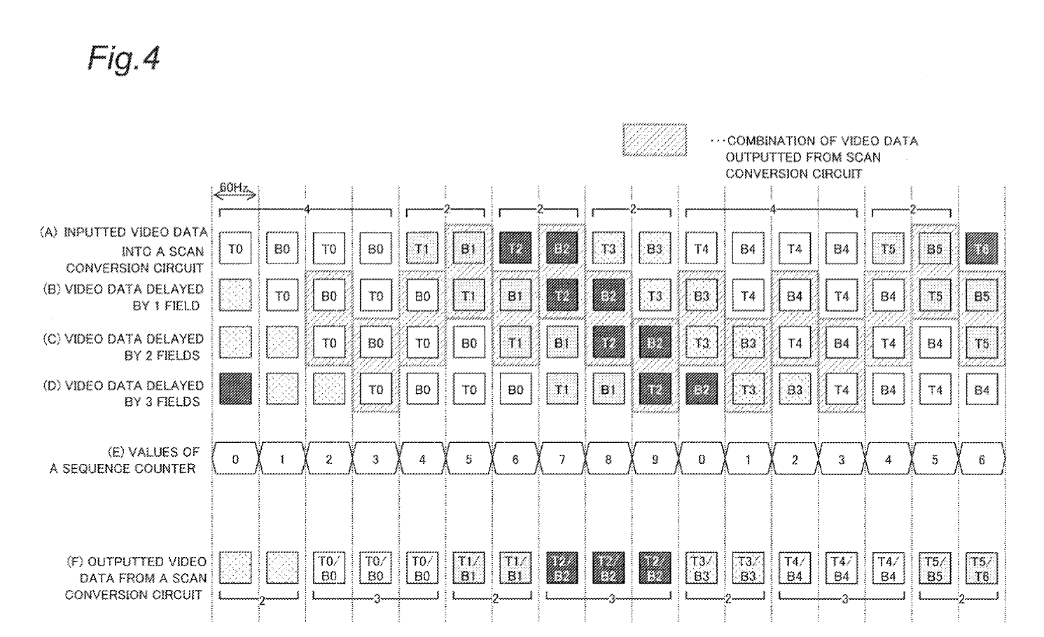

A description will be given of processing by the video processing apparatus 1 configured as above with reference to FIG. 4. FIG. 4(A) illustrates interlaced video data at 60 fields per second decoded by the decoder 183 and inputted into the AV input/output circuit 184. Tn (n is an integer equal to 0 or more) and Bn (n is an integer equal to 0 or more) are a pair of fields (interlaced video data) constituting the same frame in video data of motion picture film at 24 frames per second (progressive video data). The interlaced video data Tn and Bn are video data whose video show approximately the same pattern. FIG. 4(B), (C), and (D) illustrate video data delayed by one field, video data delayed by two fields, and video data delayed by three fields, respectively, which are held by the buffer memory 16. FIG. 4(E) illustrates values of a sequence counter. FIG. 4(F) illustrates progressive video data at 60 frames per second, the video data having been scan-converted by the video scan-conversion circuit 1841 of FIG. 3.

The film cadence detection circuit 1842 detects the 4:2:2:2 format. A difference between the video data outputted from the decoder 183 and the video data delayed by one field from the buffer memory 16 (hereinafter referred to as a “one-field difference” as appropriate) is calculated. Moreover, the film cadence detection circuit 1842 calculates a difference between the video data outputted from the decoder 183 and the video data delayed by two fields from the buffer memory 16 (hereinafter referred to as a “two-field difference” as appropriate). The field difference is a total value obtained by calculating an absolute value of a difference in the luminance level of an image for each corresponding pixel between images to be compared to add the calculated absolute values for all the pixels.

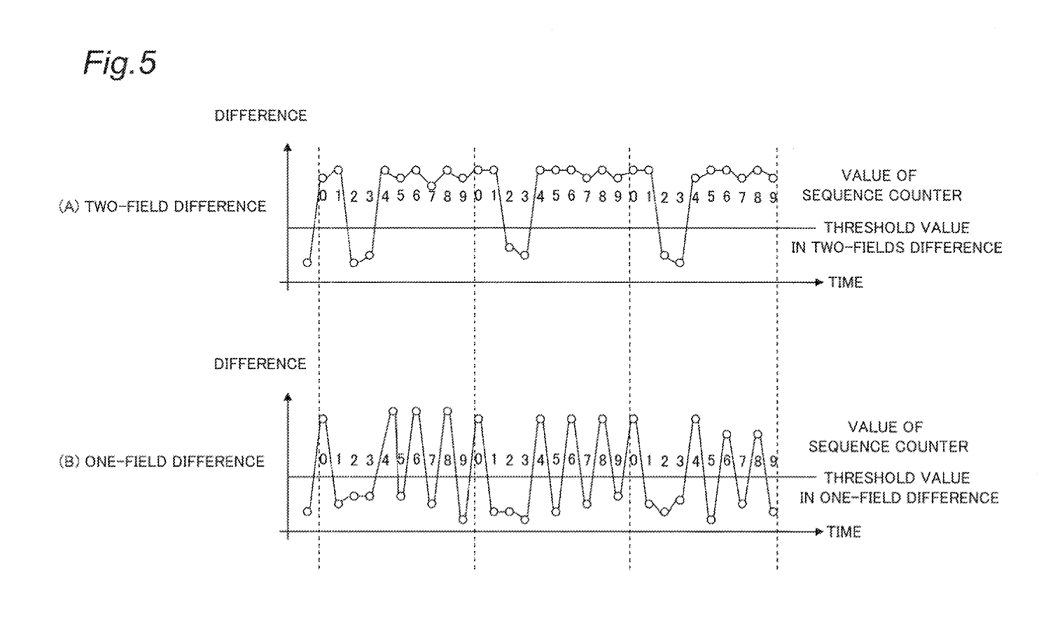

FIG. 5(A) illustrates the time transition of the two-field difference, and FIG. 5(B) illustrates the time transition of the one-field difference. It can be seen from FIGS. 5(A) and (B) that the values of the one-field difference and the two-field difference periodically fluctuate in every 10 fields. For example, assuming that when the value of the two-field difference is equal to a threshold value or more, the field difference is expressed as one, when the value of the two-field difference is less than the threshold value, the field difference is expressed as “zero”, it can be seen that there is a section of being zero in two consecutive fields in 10 fields. The film cadence detection circuit 1842 detects such periodic fluctuations in the field difference and accordingly detects that inputted data is in the 4:2:2:2 format.

When consecutively detecting the periodic fluctuations in the field difference as shown in FIGS. 5(A) and (B), the film cadence detection circuit 1842 determines that the inputted video data is interlaced video data in the 4:2:2:2 format. Incidentally, both or either of the one-field difference and two-field difference may be used for the detection of video data.

The film cadence detection circuit 1842 sends the detection result showing the presence or absence of video data in the 4:2:2:2 format and the value of the sequence counter to be set based on the detection result to the scan-conversion circuit 1841. The sequence counter is a counter which shows where each video data constituting the 4:2:2:2 format is located in video data equivalent to 10 fields constituting the 4:2:2:2 format, and shows any value of zero to nine.

Based on the detection result showing the presence or absence of the video data in the 4:2:2:2 format in the film cadence detection circuit 1842 and the value of the sequence counter (refer to FIG. 4(F)), the scan-conversion circuit 1841 combines predetermined two video data in the above video data of four fields in total (the video data outputted from the decoder 183 (the video inputted into the scan-conversion circuit 1841) and the video data of the past three fields held by the buffer memory 16 (the video data delayed by one field, the video data delayed by two fields, and the video data delayed by three fields)) to generate progressive video data. Specifically, if the detection result of the film cadence detection circuit 1842 shows detection of video data in the 4:2:2:2 format, the scan-conversion circuit 1841 combines predetermined two interlaced video data in the above video data of four fields in total (FIG. 4(A), (B), (C), and (D)) based on the value of the sequence counter (refer to FIG. 4(F)) such that the output of the scan-conversion circuit 1841 is the same as the video generated by the 3:2 pulldown conversion to generate the progressive video data shown in FIG. 4(E).

A specific description will be given of the operation of the video processing apparatus 1 with reference to FIG. 4. For example, if the value of the sequence counter is two, interlaced video data (B0) delayed by one field and interlaced video data (T0) delayed by two fields are combined to generate progressive video data (output video data) (T0/B0). If the value of the sequence counter is three, interlaced video data (B0) delayed by two fields and interlaced video data T0 delayed by three fields are combined to generate the progressive video data (T0/B0). If the value of the sequence counter is four, the interlaced video data (T0) delayed by two fields and the interlaced video data (B0) delayed by one field are combined to generate the progressive video data (T0/B0). If the value of the sequence counter is five, video B1 inputted into the scan-conversion circuit 1841 and interlaced video data T1 delayed by one field are combined to generate the progressive video data T0/B0. If the value of the sequence counter is six, interlaced video data (B1) delayed by one field and interlaced video data (T1) delayed by two field is are combined to generate progressive video data (T1/B1). Such combinations make it possible to obtain the same progressive video data (T0/B0) if the values of the sequence counter are two, three, and four, and obtain the same video data (T1/B1) of the progressive video if the values of the sequence counter are five and six. The combinations as shown in FIG. 4 make it possible to subsequently obtain 3:2 pulldown video where the same images are repeated in three frames, two frames, three frames, . . . . Incidentally, the above combinations for the values of the sequence counter are merely examples. For example, if the value of the sequence counter is three, video data (T0) delayed by one field and the video data (B0) delayed by two fields may be combined, or input video of the scan-conversion circuit 1841 and the video data (T0) delayed by one field may be combined. In short, it is sufficient if two fields of interlaced video data are combined in interlaced video data of four fields in total so that the progressive video data (T0/B0) in the 3:2 pulldown format can be obtained. Moreover, it is sufficient if two fields of interlaced video data are combined in interlaced video data of four fields in total so that the progressive video data (T1/B1) can be obtained when the values of the sequence counter are five and six.

As described above, the video processing apparatus 1 of the first embodiment converts inputted video data into video data at 60 frames per second in the 3:2 pulldown format to output the video data if the inputted video data is video data at 60 fields per second in the 4:2:2:2 format. Accordingly, even if inputted video data is video data at 60 fields per second in the 4:2:2:2 format, it is possible to solve the problem that the motions of video are unnatural when viewed by the user.

### Second Embodiment

A description will be given of the configuration different from that of the first embodiment, for solving the above first problem.

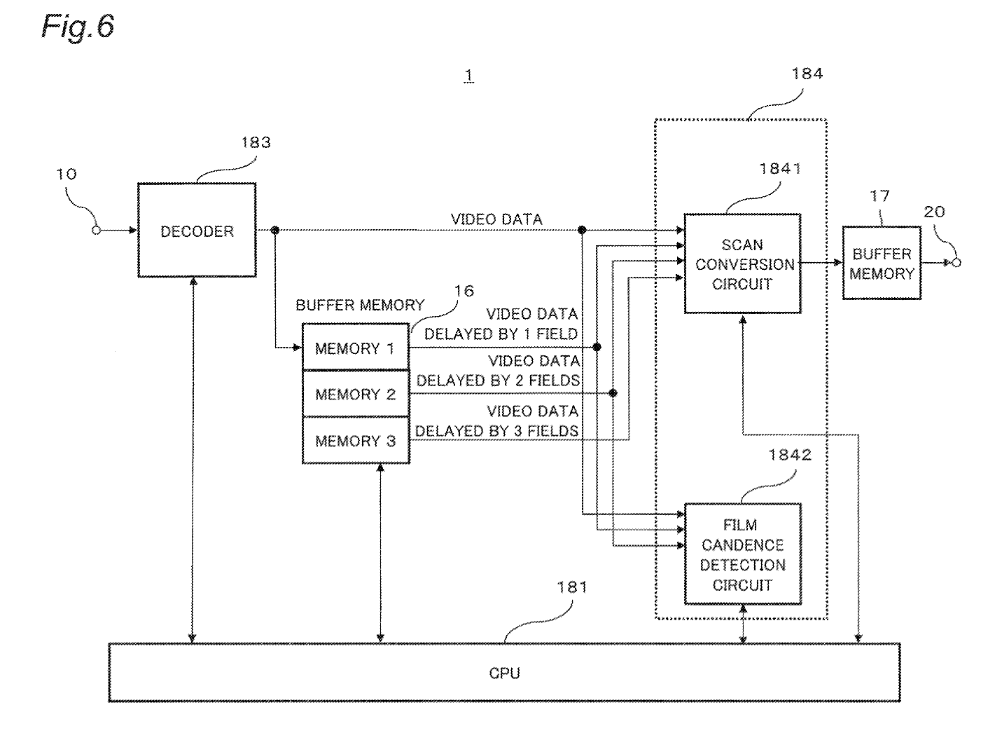

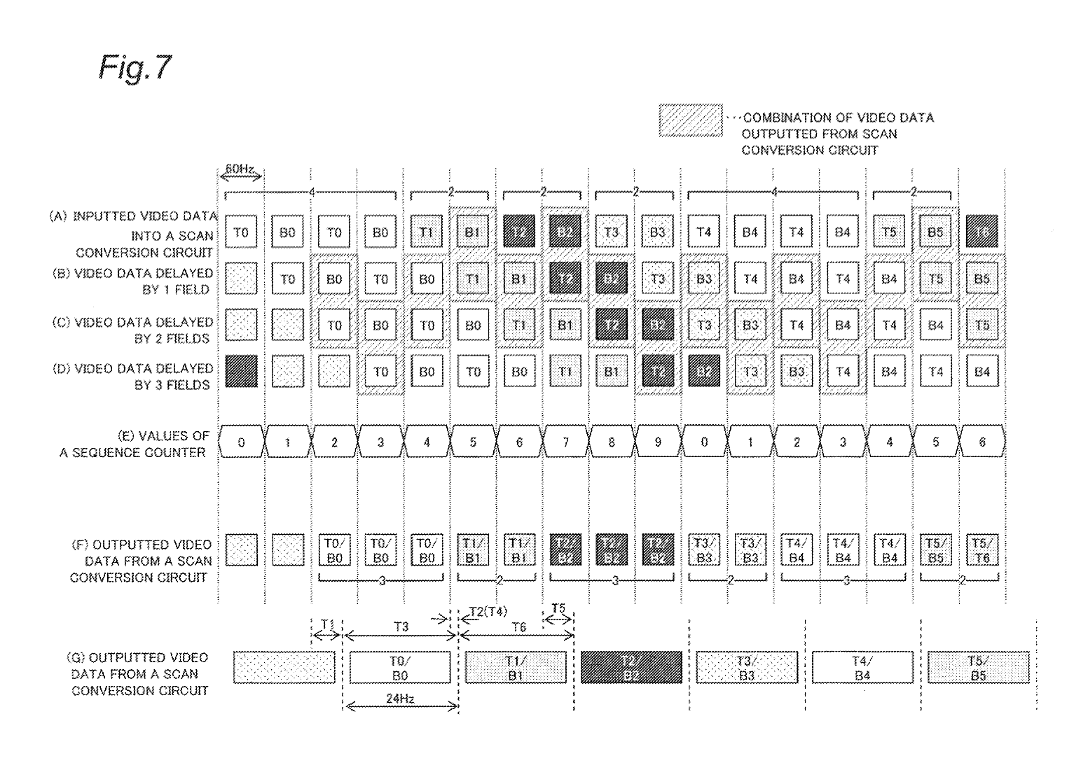

The description was given of the case where the video processing apparatus 1 outputs progressive video data at 60 frames per second in the first embodiment. A description will be given of the configuration for a case of outputting progressive video data at 24 frames per second in the second embodiment with reference to FIGS. 6 and 7. FIG. 6 is a view illustrating the configuration of a video processing apparatus 1 of the second embodiment. FIG. 7(A) is a view illustrating the processing of the video processing apparatus 1 of the second embodiment. The video processing apparatus 1 of the second embodiment includes a buffer memory 17 in the subsequent stage of the scan-conversion circuit 1841 in addition to the elements of the video processing apparatus 1 of the first embodiment shown in FIG. 3.

The buffer memory 17 includes at least two frame memories and converts a frame rate. A progressive video data at 60 frames per second outputted from the scan-conversion circuit 1841 is inputted into the buffer memory 17. The buffer memory 17 adjusts an output timing of the progressive video data at 60 frames per second inputted from the scan-conversion circuit 1841 based on the detection result obtained from the film cadence detection circuit 1842 and the value of the sequence counter, and accordingly outputs progressive video data at 24 frames per second before the 3:2 pulldown conversion.

For example, as shown in FIG. 7(G), the buffer memory 17 outputs the progressive video data (T0/B0) outputted from the scan-conversion circuit 1841 when the value of the sequence counter is two, for a third predetermined time T3 ( 1/24 second) after a lapse of a first predetermined time T1 since the value of the sequence counter becomes two, until a second predetermined time T2 elapses since the value of the sequence counter becomes five. Moreover, the buffer memory 17 outputs the progressive video data (T1/B1) outputted from the scan-conversion circuit 1841 when the value of the sequence counter is five, for a sixth predetermined time T6 ( 1/24 second) after a lapse of a fourth predetermined time T4 since the value of the sequence counter becomes five, until a fifth predetermined time T5 elapses since the value of the sequence counter becomes seven. Similarly, the progressive video data (T1/B1) outputted from the scan-conversion circuit 1841 is hereafter outputted for a predetermined time ( 1/24 second) based on the value of the sequence counter, accordingly, progressive video data at 24 frames per second having the same content as that before the 3:2 pulldown conversion is outputted.

As described above, if inputted video data is video data at 60 fields per second in the 4:2:2:2 format, the video processing apparatus 1 of the second embodiment converts the inputted video data into video data at 24 frames per second where all frames, which are bases of the generation of the inputted video data, are different to output the converted video data. Accordingly, even if inputted video data is video data at 60 fields per second in the 4:2:2:2 format, it is possible to solve the problem that the motions of video are unnatural when viewed by the user.

### Third Embodiment

A third embodiment is for solving the above fourth problem. More specifically, progressive video data at 30 frames per second generated in the procedures as in FIG. 16 and distributed from the server 3 is in the 2:1:1:1 format. If the progressive video data at 30 frames per second in the 2:1:1:1 format is scan-converted into progressive video data at 60 frames per second, the video data generated by the scan-conversion is turned into video data in the 4:2:2:2 format. If the video data in the 4:2:2:2 format is played back, the motions of the video become unnatural. A description will be given in the third embodiment of the configuration of a video processing apparatus 1 for solving the problem.

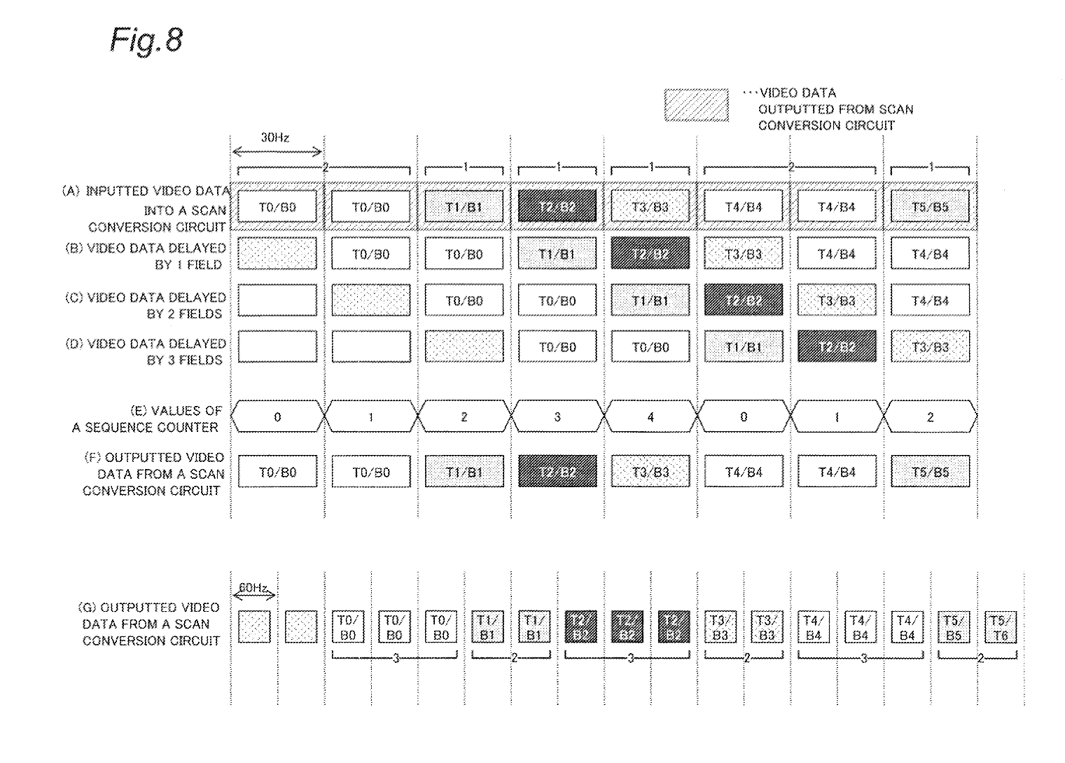

In the first embodiment, it is described that the case where the video data outputted from the decoder 183 of the video processing apparatus 1 is interlaced video data at 60 fields per second. In the third embodiment, it is described that a case where the output of the decoder 183 is progressive video data at 30 frames per second, with reference to FIG. 8. The configuration of the video processing apparatus 1 is the same as that of the video processing apparatus 1 described in the second embodiment and shown in FIG. 6. Video data at 30 frames per second decoded by the decoder 183 is progressive video data in the 2:1:1:1 format repeated in a cycle of two frames, one frame, one frame, and one frame as shown in FIG. 8(A). Similarly to the detection of interlaced video data in the 4:2:2:2 format, the film cadence detection circuit 1842 shown in FIG. 6 detects periodic fluctuations in the frame difference and accordingly detects that the video data is progressive video data in the 2:1:1:1 format.

The buffer memory 17 includes at least two frame memories, and converts a frame rate. The progressive video data at 30 frames per second outputted from the scan-conversion circuit 1841 is inputted into the buffer memory 17. The buffer memory 17 adjusts an output timing of the progressive video data at 30 frames per second inputted from the scan-conversion circuit 1841 based on the detection result obtained from the film cadence detection circuit 1842 and the value of the sequence counter (FIG. 8(F)), and accordingly outputs progressive video data at 60 frames per second.

For example, as shown in FIG. 8, the buffer memory 17 outputs progressive video data (T0/B0) inputted from the scan-conversion circuit 1841 when the value of the sequence counter is one, three consecutive times in a cycle of 1/60 second. Moreover, the buffer memory 17 outputs progressive video data (T1/B1) inputted from the scan-conversion circuit 1841 when the value of the sequence counter is two, two consecutive times in a cycle of 1/60 second after outputting third progressive data (T0/B0). The buffer memory 17 outputs progressive video data (T2/B2) inputted from the scan-conversion circuit 1841 when the value of the sequence counter is three, two consecutive times in a cycle of 1/60 second after outputting second progressive video data (T1/B1). Afterwards, progressive video data inputted from the scan-conversion circuit 1841 is outputted based on the value of the sequence counter, accordingly, progressive video data at 60 frames per second in the 3:2 pulldown format is outputted.

As described above, if inputted video data is video data at 30 frames per second in the 2:1:1:1 format, the video processing apparatus 1 of the third embodiment converts the inputted video data into video data at 60 frames per second in the 3:2 pulldown format to output the converted video data. Accordingly, even if inputted video data is video data at 30 frames per second in the 2:1:1:1 format, it is possible to solve the problem that the motions of video are unnatural when viewed by the user.

### Fourth Embodiment

The fourth embodiment is for solving the above second problem. More specifically, if interlaced video data at 60 fields per second in the 2:2:2:2:2 format (video data including a frame generated by combining two different images) is converted into progressive video data at 60 frames per second, the progressive video data at 60 frames per second also includes a frame generated by combining different images. Accordingly, there is a problem that image according to the progressive video data at 60 frames looks double or smeared when viewed. In the fourth embodiment, a description will be given of the configuration of a video processing apparatus 1 for solving the problem.

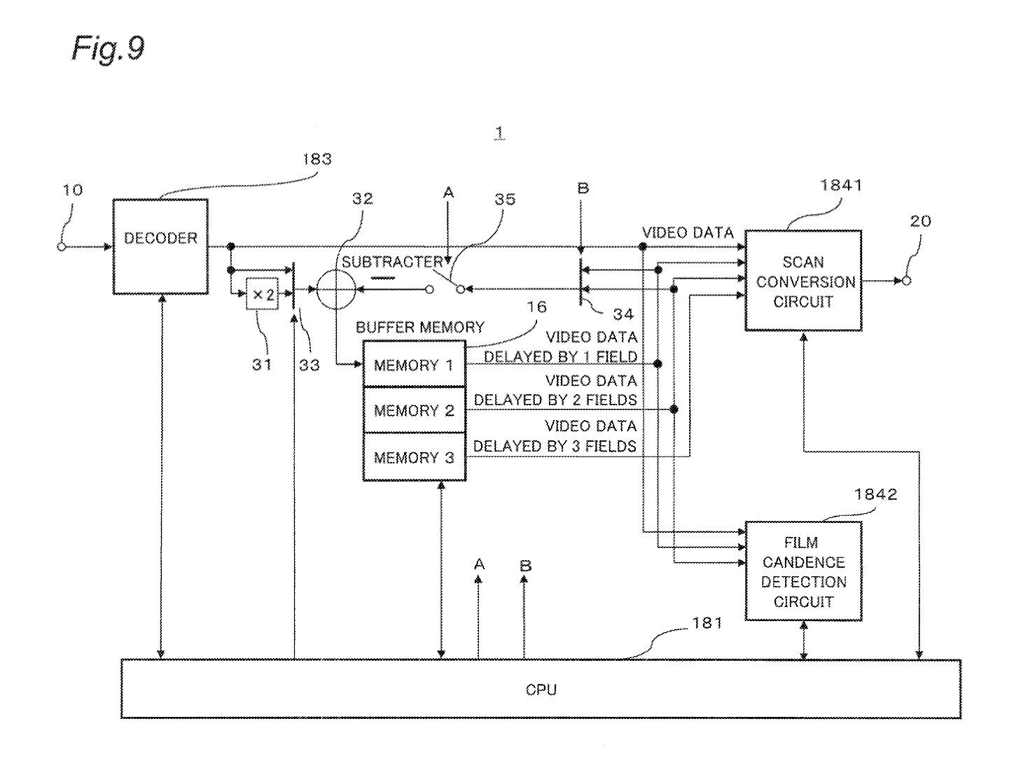

FIG. 9 is a view illustrating the configuration of the video processing apparatus 1 of the fourth embodiment. The video processing apparatus 1 of the fourth embodiment includes a multiplier 31, a subtracter 32, a first selector 33, a second selector 34, and a switch 35 in addition to the elements in the video processing apparatus 1 of the first embodiment. The same parts as those of the first embodiment will not be neglected.

The multiplier 31 doubles an output from the decoder 183 to output it.

The selector 33 selectively outputs any one of the video data outputted from the decoder 183 and video data outputted from the multiplier 31.

The selector 34 selectively outputs any one of video data delayed by one field, and video data delayed by two fields, which are outputted from the buffer memory 16.

The switch 35 opens and closes to connect and disconnect the output of the selector 34 and a negative input of the subtracter 32.

The subtracter 32 subtracts the output of the selector 34 from the output of the selector 33 to output the subtraction result to the buffer memory 16.

If video data inputted into the scan-conversion circuit 1841 is interlaced video data at 60 fields per second, the CPU 181 causes the selector 34 to output video data delayed by two fields from the buffer memory 16. On the other hand, if video data inputted into the scan-conversion circuit 1841 is progressive video data at 30 frames per second, the CPU 181 causes the selector 34 to output video data delayed by one field from the buffer memory 16.

Moreover, when the value of the sequence counter is a predetermined value, the CPU 181 controls the selector 33 to output the output of the multiplier 31. For example, if video data inputted into the scan-conversion circuit 1841 is interlaced video data at 60 fields per second, the CPU 181 causes the selector 33 to output the output of the multiplier 31 when the values of the sequence counter are three and four. Furthermore, if video data inputted into the scan-conversion circuit 1841 is progressive video data at 30 frames per second, the CPU 181 causes the selector 33 to output the output of the multiplier 31 when the value of the sequence counter is two.

Moreover, when the value of the sequence counter is a predetermined value, the CPU 181 controls the switch 35 to close. For example, if video data inputted into the scan-conversion circuit 1841 is interlaced video data at 60 fields per second, the CPU 181 controls the switch 35 to close when the values of the sequence counter are three and four. Furthermore, if video data inputted into the scan-conversion circuit 1841 is progressive video data at 30 frames per second, the CPU 181 controls the switch 35 to close when the value of the sequence counter is two.

Moreover, when the value of the sequence counter is five, the CPU 181 overwrites the video data delayed by two fields from the buffer memory 16 of a case where the value of the sequence counter is four as video data delayed by one field in the memory (1) of the buffer memory 16.

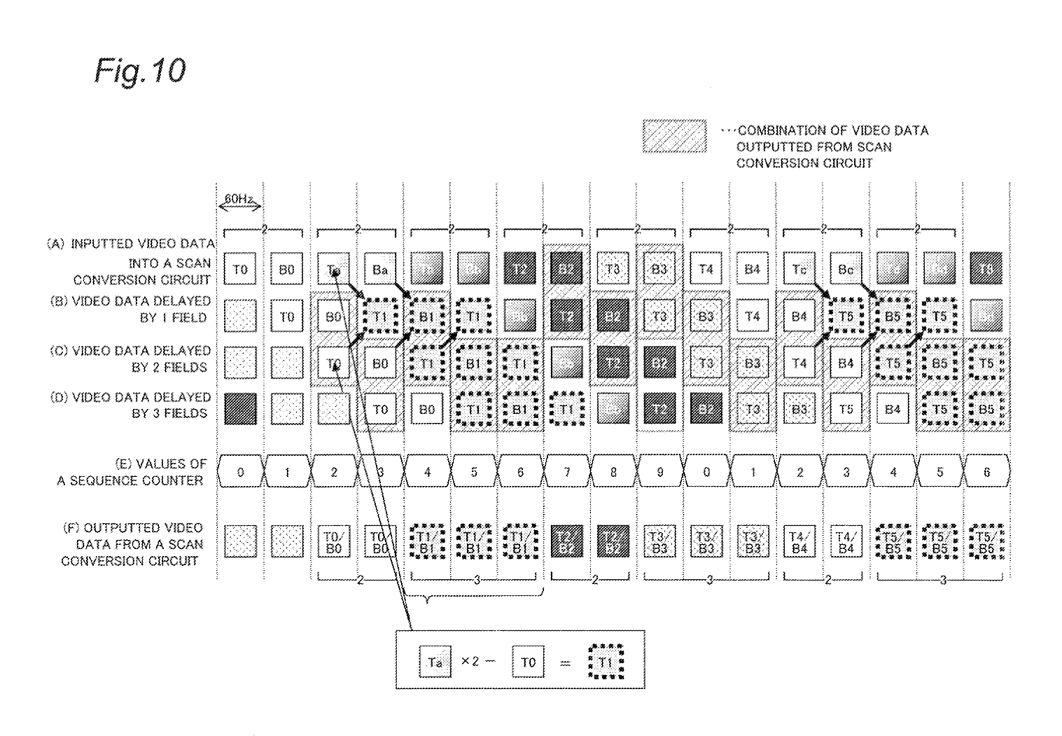

According to such a configuration, as shown in FIG. 10, when the value of the sequence counter is three, the video data T0 delayed by two fields of a case where the value of the sequence counter is two is subtracted from video data 2Ta where video data Ta inputted into the scan-conversion circuit 1841 of a case where the value of the sequence counter is two is doubled. Accordingly, the video data T1 is generated, and the video data T1 is overwritten as video data of a memory output delayed by one field of a case where the value of the sequence counter is three.

Moreover, when the value of the sequence counter is four, the video data B0 delayed by two fields outputted from the buffer memory 16 is subtracted from video data where video data Ba inputted into the scan-conversion circuit 1841 of a case where the value of the sequence counter is three is doubled. Accordingly, the video data T1 is generated. The video data T1 is overwritten as video data of an output delayed by one field of a case where the value of the sequence counter is four.

Moreover, when the value of the sequence counter is five, the video data T1 of an output delayed by two fields in the buffer memory 16 of a case where the value of the sequence counter is four is overwritten as video data of an output delayed by one field of a case where the value of the sequence counter is five.

Incidentally, similarly to the case of FIG. 5, video data in the 2:2:2:2:2 format which should look double or smeared when viewed as shown in FIG. 17(E) can be distinguished as follows:

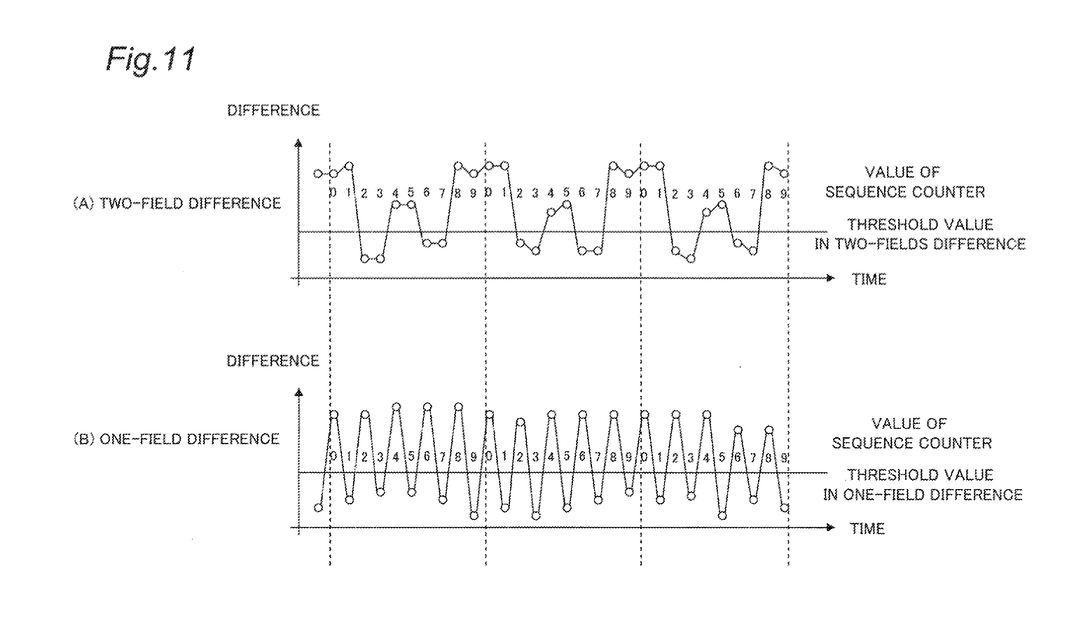

FIG. 11(A) illustrates the time transition of the two-field difference, and FIG. 11(B) illustrates the time transition of the one-field difference. It can be seen from FIG. 11 that the values of the one-field difference and the two-field difference periodically fluctuate in every 10 fields. For example, assuming that when the value of the two-field difference is equal to a threshold value or more, the field difference is expressed as one, when the value of the two-field difference is less than the threshold value, the field difference is expressed as “zero”, it can be seen that there are two units of zero in two consecutive fields in 10 fields. Moreover, it can be seen that the value of the field difference appears alternately as one and zero in the one-field difference of FIG. 11(B). The film cadence detection circuit 1842 detects such periodic fluctuations in the field difference and accordingly detects video data in the 2:2:2:2:2 format.

Incidentally, when the value of the sequence counter is two, the video data T0 delayed by two fields is subtracted from the inputted video data T1, however, the video data B0 delayed by one field may be used for the subtraction. Alternatively, the selection of video data to be used can be changed as appropriate according to the state of image displayed based on the video data decoded by the decoder 183 and the like.

If video data inputted into the scan-conversion circuit 1841 is video data at 60 frames per second in the 2:2:2:2:2 format, the video processing apparatus 1 of the fourth embodiment corrects the inputted video data by use of video data inputted before the video data is inputted and then converts the inputted video data into video data at 60 frames per second in the 3:2 pulldown format to output the video data. Accordingly, even if inputted video data is video data at 60 frames per second in the 2:2:2:2:2 format, the problem of an image looking double or smeared when viewed is resolved.

### Fifth Embodiment

A fifth embodiment is for solving the above third problem. More specifically, if progressive video data at 30 frames per second in the 1:1:1:1:1 format (video data including a frame generated by combining images of two different frames) is converted into progressive video data at 60 frames per second, the progressive video data at 60 frames per second also includes a frame generated by combining different images. Accordingly, there is the problem that the progressive video data at 60 frames per second looks double or smeared when viewed. A description will be given in the fifth embodiment of the configuration of a video processing apparatus 1 for solving the problem.

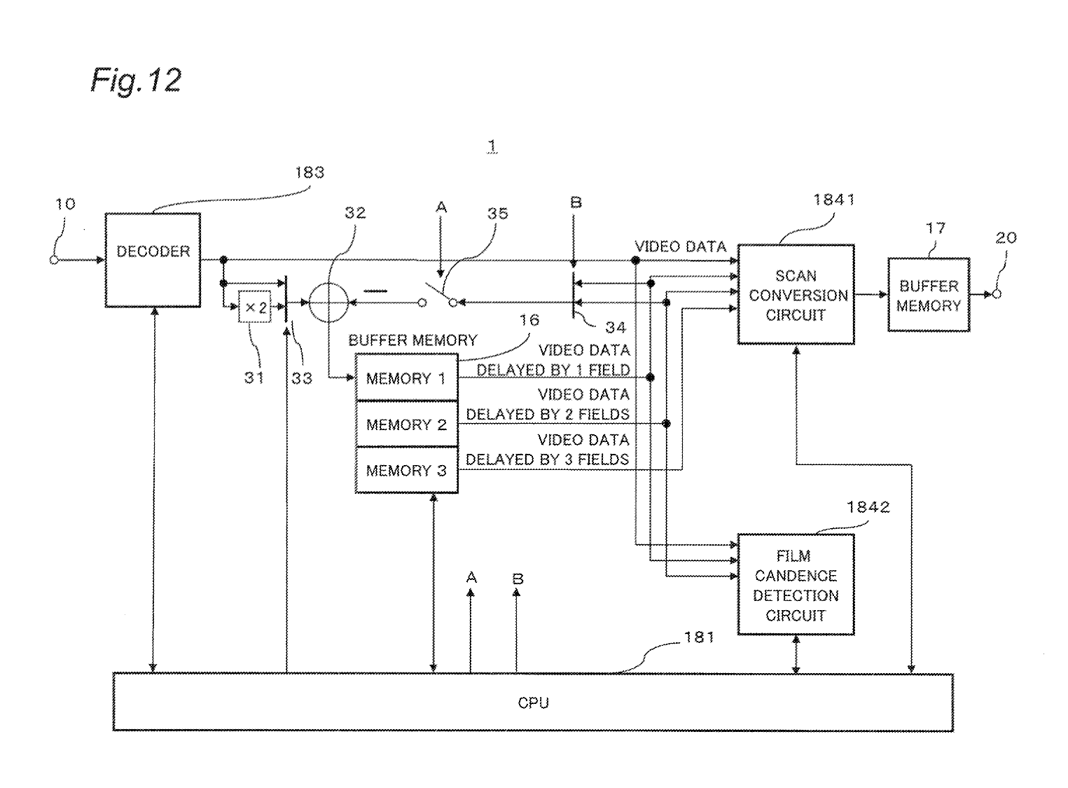

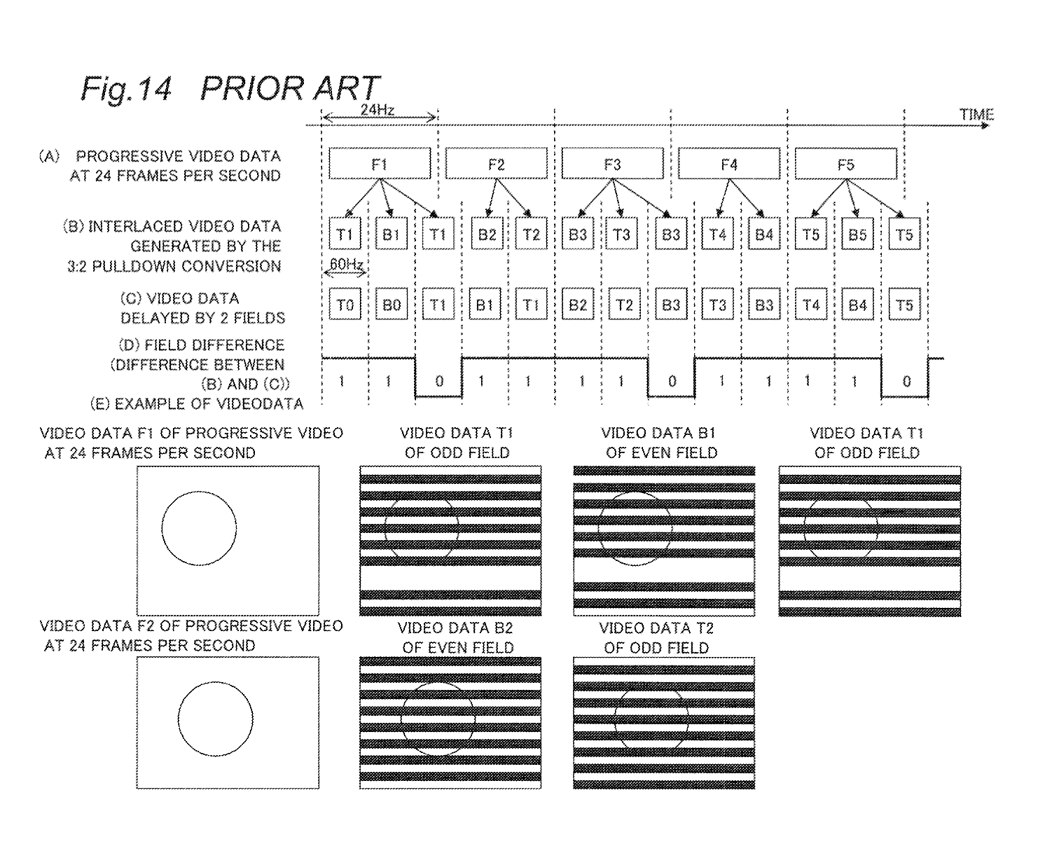

A description will be given of the video processing apparatus 1 of the fifth embodiment with reference to FIG. 12 and FIG. 14. The video processing apparatus 1 of the fifth embodiment further includes a buffer memory 17 in addition to the video processing apparatus 1 described in the fourth embodiment (FIG. 9).

The buffer memory 17 includes at least two frame memories and converts a frame rate. Progressive video data at 30 frames per second outputted from the scan-conversion circuit 1841 is inputted into the buffer memory 17. The buffer memory 17 adjusts an output timing of the progressive video data at 30 frames per second inputted from the scan-conversion circuit 1841 based on the detection result obtained from the film cadence detection circuit 1842 and the value of the sequence counter, and accordingly outputs progressive video data at 60 frames per second in the 3:2 pulldown format.

Moreover, when the value of the sequence counter is a predetermined value, the CPU 181 causes the selector 33 to output an output of the multiplier 31. For example, if video data to be inputted is progressive video data at 30 frames per second, the CPU 181 causes the selector 33 to output an output of the multiplier 31 when the value of the sequence counter is two.

Moreover, when the value of the sequence counter is a predetermined value, the CPU 181 controls the switch 35 to close. For example, if video data to be inputted is progressive video data at 30 frames per second, the CPU 181 controls the switch 35 to close when the value of the sequence counter is two.

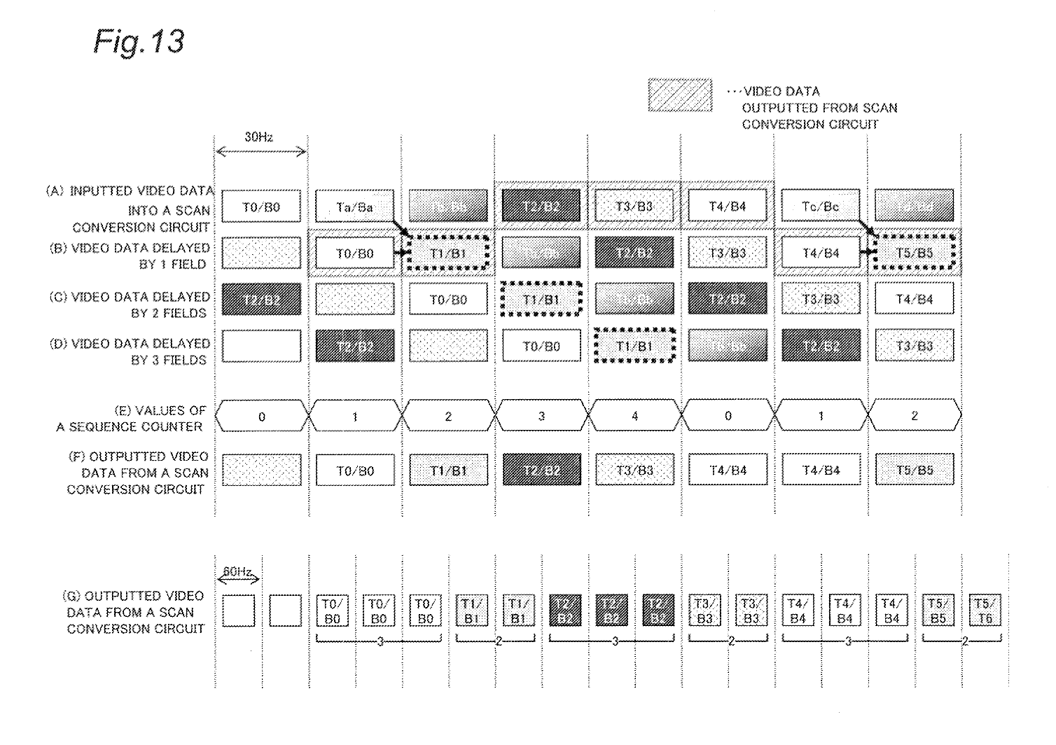

According to such a configuration, as shown in FIG. 13, when the value of the sequence counter is two, video data T0/B0 of an output delayed by one field from the buffer memory 16 is subtracted from video data Ta/Ba inputted into the scan-conversion circuit 1841 of a case where the value of the sequence counter is one. Accordingly, video data T1 before the images are combined is generated. When the value of the sequence counter is two, the video data T1 is overwritten as video data delayed by one field in the buffer memory 16.

If inputted video data is video data at 30 frames per second in the 1:1:1:1:1 format, the video processing apparatus 1 of the fifth embodiment corrects the inputted video data by use of video data inputted before the video data is inputted and then converts the inputted video data into video data at 60 frames per second in the 3:2 pulldown format to output the video data. Accordingly, even if inputted video data is video data at 30 frames per second in the 1:1:1:1:1 format, the problem of an image looking double or smeared when viewed is resolved.

### Other Embodiments

The descriptions were given of the case where video data is received from the Internet to be played back in the first to fifth embodiments. However, this is merely an example. For example, the technical ideas of the above embodiments can be applied also to a case where a recorded digital broadcasting program, a DVD, and the like are played back.

In the descriptions of the above embodiments, a fact that video data is generated by the 3:2 pulldown conversion is detected by the film cadence detection circuit 1842 by use of the regularity of the field difference. However, the processing is not essential. For example, a stream of digital broadcasting (an MPEG2 transport stream) includes various control information, in which an identifier called a RFF (Repeat First Flag) shows whether or not the data stream has been generated by the 3:2 pulldown conversion. The CPU 181 of the video processing apparatus 1 may perform the processing of detecting an identifier instead of detecting the regularity of the field difference detection processing.

In the above embodiments, a single semiconductor chip LSI 18 is configured of the CPU 181, the stream controller 182, the decoder 183, the AV input/output circuit 184, the bus 185, and the memory controller 186, which constitute the video processing apparatus 1. However, this is merely an example. These elements may be configured of two or more chips, or the elements may be realized by different chips individually or as a memory module.

In the present embodiments, the video data conversion apparatus is installed in the video processing apparatus 1. However, the LSI 18 can be installed in the TV 2. Furthermore, if the video data conversion apparatus has the function of receiving a video stream through the internet 500 and playing back the video, it can be installed widely. For example, it can be installed in a recorder or a player, which receives, decodes, and plays back a video stream on the internet 500. Moreover, it can be installed in an unillustrated PC (personal computer), a mobile phone, a mobile media player, a PDA, and a car navigation system. Moreover, the technical ideas of the above embodiments can be realized as a discrete video data conversion apparatus having the video data conversion function described in any of the above embodiments.

The video processing apparatus 1 of the above embodiments operates based on a computer program. For example, the video processing apparatus 1 of the first embodiment operates based on a computer program where the procedures shown in FIG. 4 and the like are described. Such a computer program can be recorded in an optical disk or a flash memory card, or can be transferred through a network.

### INDUSTRIAL APPLICABILITY

The video data conversion apparatus of the above embodiments is for scan-converting video data generated by the 3:2 pulldown conversion and is suitably used in a video display device and a video processing apparatus.

What is claimed is:

1. A video data conversion apparatus capable of converting inputted video data in a predetermined scanning format into video data in another scanning format, wherein
the inputted video data in the predetermined scanning format is video data at 60 fields per second in a 4:2:2:2 format,
the video data in the 4:2:2:2 format is video data in a format where four fields generated from one original image, two fields generated from a next original image, two fields generated from a further next original image, and two fields generated from a still further next original image appear periodically in this order,
the video data conversion apparatus comprises a conversion unit operable to convert the inputted video data into video data at 60 frames per second in a 3:2 pulldown format.

2. The video data conversion apparatus according to claim 1, further comprising:
a detection unit operable to detect whether the inputted video data is the video data at 60 fields per second in the 4:2:2:2 format; and
a storing unit operable to store the inputted video data, wherein
when the detection unit determines that the inputted video data is the video data at 60 fields per second in the 4:2:2:2 format, the conversion unit reads the video data stored in the storing unit, and converts the read video data into video data at 60 frames per second in the 3:2 pulldown format to output the converted video data.

3. The video data conversion apparatus according to claim 2, wherein the detection unit detects that inputted video data is the video data at 60 fields per second in the 4:2:2:2 format by detecting a difference between data of a predetermined field and data of a field delayed by two fields from the predetermined field in the video data stored in the storing unit.

4. The video data conversion apparatus according to claim 3, wherein the detection unit detects that inputted video data is the video data at 60 fields per second in the 4:2:2:2 format, by detecting a difference between the video data stored in the storing unit and video data delayed by one field, and accordingly.

5. A video data conversion apparatus capable of converting inputted video data in a predetermined scanning format into video data in another scanning format,
the inputted video data in the predetermined scanning format is video data at 60 fields per second in a 4:2:2:2 format,
the video data in the 4:2:2:2 format is video data in a format where four fields generated from one original image, two fields generated from a next original image, two fields generated from a further next original image, and two fields generated from a still further next original image appear periodically in this order,
the video data conversion apparatus comprises a conversion unit operable to convert the inputted video data into video data at 24 frames per second where all frames are bases of generation of the video data are different to output the video data.

6. The video data conversion apparatus according to claim 5, further comprising:
a detection unit operable to detect whether or not inputted video data is the video data at 60 fields per second in the 4:2:2:2 format; and
a storing unit operable to store the inputted video data, wherein
when the detection unit determines that the inputted video data is the video data at 60 fields per second in the 4:2:2:2 format, the conversion unit reads the video data stored in the storing unit, and converts the read video data into video data at 24 frames per second to output the converted video data.

7. A video data conversion apparatus capable of converting inputted video data in a predetermined scanning format into video data in another scanning format,
the inputted video data in the predetermined scanning format is video data at 30 frames per second in a 2:1:1:1 format,
the video data in the 2:1:1:1 format is video data in a format where two frames generated from one original image, one frame generated from a next original image, one frame generated from a further next original image, and one frame generated from a still further next original image appear periodically in this order,
the video data conversion apparatus comprises a conversion unit operable to convert the inputted video data into video data at 60 frames per second in a 3:2 pulldown format to output the video data.

8. The video data conversion apparatus according to claim 7, further comprising:
a detection unit for detecting whether or not inputted video data is the video data at 30 frames per second in the 2:1:1:1 format; and
a storing unit for storing the inputted video data, wherein
when the detection unit determines that the inputted video data is the video data at 30 frames per second in the 2:1:1:1 format, the conversion unit reads the video data stored in the storing unit, and converts the read video data into video data at 60 frames per second in the 3:2 pulldown format to output the converted video data.

9. A video data conversion apparatus capable of converting inputted video data in a predetermined scanning format into video data in another scanning format,
the inputted video data in the predetermined scanning format is video data at 60 fields per second in a 2:2:2:2:2 format,
the video data in the 2:2:2:2:2 format is video data in a format where two fields generated from one original image, two fields generated from a next original image, two fields generated from the next original image and a further next original frame, two fields generated from the further next original image, and two fields generated from a still further next original image appear periodically in this order,
the video data conversion apparatus comprises a conversion unit operable to correct the two fields generated from two original images in the inputted video data by use of the original image used for generation of another field, afterwards convert the inputted video data into video data at 60 frames per second in a 3:2 pulldown format to output the video data.

10. The video data conversion apparatus according to claim 9, further comprising:
a detection unit for detecting whether or not inputted video data is the video data at 60 fields per second in the 2:2:2:2:2 format;
a first storing unit operable to store the inputted video data; and
a second storing unit operable to store video data inputted immediately before the video data is inputted, wherein
when the detection unit determines that the inputted video data is the video data at 60 fields per second in the 2:2:2:2:2 format, the conversion unit reads the video data stored in the first and second storing units respectively, corrects the video data read from the first storing unit by use of the video data read from the second storing unit, afterwards converts the corrected video data into video data at 60 frames per second in the 3:2 pulldown format to output the converted video data.

11. A video data conversion apparatus capable of converting inputted video data in a predetermined scanning format into video data in another scanning format,
the inputted video data in the predetermined scanning format is video data at 30 frames per second in a 1:1:1:1:1 format,
the video data in the 1:1:1:1:1 format is video data in a format where one field generated from one original image, one field generated from a next original image, one field generated from the next original image and a further next original image, one field generated from the further next original image, and one field generated from a still further next original image appear periodically in this order,
the video data conversion apparatus comprises a conversion unit operable to correct the one field generated from the two original images in the inputted video data by use of the original image used for generation of another field, afterwards convert the inputted video data into video data at 60 frames per second in a 3:2 pulldown format to output the video data.

12. The video data conversion apparatus according to claim 11, further comprising:
a detection unit for detecting whether or not inputted video data is the video data at 30 frames per second in the 1:1:1:1:1 format;
a first storing unit operable to store the inputted video data; and
a second storing unit operable to store video data inputted immediately before the video data is inputted, wherein
when the detection unit determines that the inputted video data is the video data at 30 frames per second in the 1:1:1:1:1 format, the conversion unit reads the video data stored in the first and second storing units respectively, corrects the video data read from the first storing unit by use of the video data read from the second storing unit, afterwards converts the video data into video data at 60 frames per second in the 3:2 pulldown format to output the converted video data.
